(19) United States
(12) Patent Application Publication
(10) Pub. No.: US 2009/0043659 A1
(43) Pub. Date: Feb. 12, 2009

(54) Method of providing personalized advertisements

(75) Inventor: Jiyoung LEE, Seoul (KR)

Correspondence Address: EDWARDS ANGELL PALMER & DODGE LLP, P.O. BOX 55874, BOSTON, MA, 02205, US

(73) Assignee: ALTICAST CO., LTD., Seoul (KR)

(21) Appl. No.: 12/187,476

(22) Filed: Aug. 7, 2008

(30) Foreign Application Priority Data
Aug. 8, 2007 (KR) 10-2007-79745

(51) Int. Cl. G06Q 30/00

(52) U.S. Cl. 705/14

(57) ABSTRACT

A user receiver coupled to an advertisement system through a network is used to provide a method of providing a personalized advertisement. The method includes: maintaining user information related to user's video view; receiving from the advertisement system respective first advertisement control data corresponding to a plurality of first advertisements, wherein the respective first advertisement control data includes at least one first condition variable and at least one first point; comparing the user information with the first condition variable or variables; and displaying, when first conditional variables matched with the user information exist, an advertisement corresponding to a first condition variable having the highest first point among the first condition variables matched with the user information.

### CROSS-REFERENCE TO RELATED APPLICATIONS

This application claims priority from Korean Patent Application No. 2007-0079745 filed on Aug. 8, 2007, the contents of which are incorporated herein by reference in its entirety.

### TECHNICAL FIELD

The present disclosure relates to a method of providing advertisements, more particularly relates to a method of providing personalized advertisements in accordance with a view record or a purchase record of a user.

### BACKGROUND ART

Standardization of a digital broadcasting has been rapidly progressed. In addition, a method of transmitting a digital signal through a broadcasting network, a method of multiplexing data and a method of processing an image and an audio signal have been actively studied. The digital broadcasting is expected to replace an analog broadcasting sometime.

The digital broadcasting may compress information data more than the analog broadcasting. Additionally, the digital broadcasting is excellent compared to the analog broadcasting in view of transmission velocity, sound quality and image quality. Specially, the digital broadcasting has been grafted with data broadcasting in accordance with development of an interactive application.

In one-way broadcasting that has been used thus far, only a preset advertisement is unilaterally provided in a channel viewed by the user. However, personalized advertisements considering taste of the user may be provided according as the interactive digital broadcasting has been developed.

Methods of providing personalized advertisements have been proposed. The prior art methods, however, do not provide sufficient advertising effect because the advertisement is selected by using only simple information of the user.

The above information disclosed in this Background section is only for enhancement of understanding of the background of the invention and therefore it may contain information that does not form the prior art that is already known in this country to a person of ordinary skill in the art.

### SUMMARY OF DISCLOSURE

Accordingly, the present invention is provided to substantially obviate one or more problems due to limitations and disadvantages of the related art.

One object of the present invention is to provide a method of providing a personalized advertisement for enhancing an advertisement providing effect.

Another object is to provide a method of providing efficiently a personalized advertisement on the basis of individual information of a user such as user's view records, age while not revealing the individual information to an outside.

Still another object is to provide a method of providing a personalized advertisement in which advertisements are transmitted to a user receiver in advance in accordance with a schedule set by an advertisement system and the advertisements can be managed by the user receiver.

A further object is to provide a method of providing a personalized advertisement in which a particular advertisement can be selected simply and effectively according to a user's favor.

In one aspect, the present invention provides a method of providing an advertisement by using a user receiver coupled to an advertisement system through a network, which includes: maintaining user information related to user's video view; receiving from the advertisement system respective first advertisement control data corresponding to a plurality of first advertisements, wherein the respective first advertisement control data includes at least one first condition variable and at least one first point; comparing the user information with the first condition variable or variables; and displaying, when first conditional variables matched with the user information exist, an advertisement corresponding to a first condition variable having the highest first point among the first condition variables matched with the user information.

In another aspect, the present invention provides a method of providing advertisements through an advertisement system coupled to at least one user receiver through a network, which includes: matching advertisement control data with advertisements, wherein the advertisement control data includes at least one condition variable and at least one point; and transmitting the advertisements and the advertisement control data to the user receiver. In this case, the user receiver compares user information related broadcasting view with the condition variables included in the advertisement control data, and displays, when condition variables matched with the user information exist, an advertisement corresponding to a condition variable having the highest point among the condition variables matched with the user information.

In still another aspect, the present invention provides a storage medium encoded with a machine-readable computer program for implementing a method for providing personalized advertisements, the method comprising: storing advertisement control data for advertisements, wherein the advertisement control data includes at least one condition variable and at least one point; comparing preset user information with condition variables included in the advertisement control data; and displaying, when condition variables matched with the user information exist, an advertisement corresponding to a condition variable having the highest point among the condition variables matched with the user information.

According to the present methods and recording medium, condition variables and points of advertisement control data matched with advertisements can be properly set and personalized advertisement can be provided to a user.

Also, since the advertisement is selected on the basis of the user's act such as view record and purchase record of the user, the advertisement can be provided in accordance with the user's favor.

In addition, individual information of the user, e.g. view record, purchase record and video view record, etc is transmitted to an outside advertisement system, and thus the individual information of the user may be protected.

Furthermore, since an advertisement and advertisement control data are transmitted in advance to a user receiver from an advertisement system in accordance with a preset period and an advertisement is selected by the user receiver to be displayed at a proper time. Accordingly, no or less network load in accordance with real time transmission of the advertisement is generated.

The above and other aspects of the present invention are discussed in detail infra.

### BRIEF DESCRIPTION OF DRAWINGS

Embodiments of the present invention will become more apparent by describing in detail example embodiments of the present invention with reference to the accompanying drawings, in which:

FIG. 1 is a block diagram illustrating an advertisement system for providing a personalized advertisement according to one example embodiment of the present invention;

FIG. 2 is a flowchart illustrating a process of providing an advertisement according to one example embodiment of the present invention;

FIG. 3 is a flowchart illustrating a process of providing an advertisement according to another example embodiment of the present invention; and

FIG. 4 is a block diagram illustrating a user receiver according to one example embodiment of the present invention.

### DETAILED DESCRIPTION OF PREFERRED EMBODIMENTS

Embodiments of the present invention are described hereafter. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

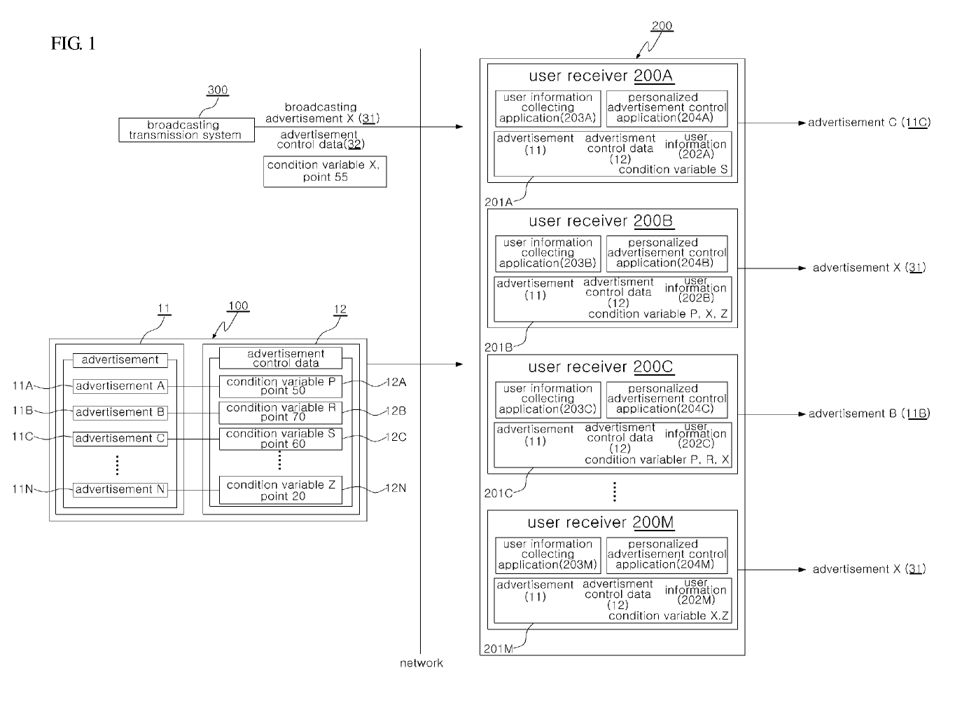

FIG. 1 is a block diagram illustrating an advertisement system for providing a personalized advertisement according to one example embodiment of the present invention.

As shown in FIG. 1, the advertisement system 100 is coupled to user receivers 200A to 200M through a network. Here, the network includes, for example, a wire network having an Internet and an exclusive line, and a wireless network having a mobile communication network, a broadcasting network and a satellite communication network.

The advertisement system 100 stores advertisements 11A to 11N, i.e. 11 and advertisement control data 12A to 12N, i.e. 12 matched with the advertisements 11A to 11N, respectively.

The advertisement 11 may various types of contents. Examples of advertisement contents include a specific goods, corporate image, and other non-profit advertisement contents, etc.

In one embodiment, the advertisements 11A to 11N are matched with the advertisement control data 12A to 12N, respectively. For example, the advertisement 11A is matched with the advertisement control data 12A, and the advertisement 11B is matched with the advertisement control data 12B.

The advertisement control data 12 suitably includes a condition variable and a point corresponding to the condition variable. Here, the condition variable and the point mean a condition for displaying a certain advertisement on the user receivers 200A to 200M.

For instance, the advertisement control data 12A matched with the advertisement 11A has a condition variable P and a point 50, and the advertisement control data 12B has a condition variable R and a point 70. In addition, the advertisement control data 12C has a condition variable S and a point 60, and the advertisement control data 12N has a condition variable Z and a point 20.

The condition variable of the present embodiment relates to act of the user. It may be defined as information of the act (e.g., video view or purchase), information of object of the act (e.g., viewed channel, video on demand, genre, purchased goods, channel on demand, pay-per-view channel), information of period of the act, information of frequency of the act, or any combination thereof.

For example, in case that the advertisement 11A corresponds to “video on demand” advertisement, a corresponding condition variable may be set to “a case that a user views a movie one time or more in recent three days”.

The condition variable is compared with user information stored in the user receivers 200A to 200M. In one example embodiment of the present invention, the user information may include one of a viewed channel record, an electronic commerce record by the user, a view record of a video on demand by the user, a view time pattern of the user, a favorite channel, a view area of the user and user's age, or their combination. Here, the favorite channel may be a channel inputted directly by the user, a channel that the user views frequently, or a channel that many users view in a specific time zone.

In another example embodiment of the present invention, the condition variable includes additional information. Examples of the additional information may include view time patterns, favorite channels, view areas, age, hobby.

On the other hand, a process of comparing the condition variable with the user information may be performed so as to replace a first advertisement in a broadcasting channel the user is viewing by a second advertisement.

In one embodiment, the second advertisement having the same displaying time as the first advertisement in the broadcasting channel may be selected. To perform the above process, the condition variable may further include advertisement displaying time information. In this case, the condition variable concerning an advertisement for “video on demand” may be set as, for example, “a case that a displaying time is 30 seconds, and a user views one time or more a movie in recent 3 days.”

The point is defined as an index of the effect when a corresponding condition variable is satisfied, meaning a numerical value indicating interest of the user. For example, in case that a point 50 is included in the advertisement control data 12A matched with the advertisement 11A, the point 50 means the effect when the condition variable P is satisfied. Here, the point is set as a score for the purpose of convenience of description, but may be assigned as a grade, e.g. A+, B, AAA−, etc.

The advertisement control data 12 matched to the advertisement 11 is transmitted from the advertisement system 100 to the user receivers 200A to 200M, i.e. 200. Then, the transmitted advertisement control data are stored in storage mediums 201A to 201M, i.e. 201 of the user receiver 200.

In case that only the advertisement control data 12 is transmitted in advance to the user receiver 200, the advertisement control data 12 may further include identification information concerning the matched advertisement 11. Here, a corresponding advertisement 11 as well as the advertisement control data 12 may be transmitted in advance to the user receiver 200, and then stored in the storage medium 201 of the user receiver 200.

In one example embodiment of the present invention, the user information 202A to 202M, i.e. 202 is stored in the storage medium 201 in the user receiver 200.

The user information 202 is obtained by user information collecting applications 203A to 203M, i.e. 203 in the user receiver 200, or is inputted directly by the user. Here, the user information collecting application 203 may be a program or an application included in a software layer.

As described above, the user information of the present embodiment is information related to broadcasting view of the user, and includes the channel record viewed by the user, the electronic commerce record by the user, the view record of a video on demand by the user, the view time pattern of the user, the favorite channel, the view area of the user and the user's age, a user's sex and a hobby, etc.

The user receiver 200 compares the condition variable, e.g. the view record, the user's age, the sex, the hobby, the view area, etc. included in the advertisement control data with the user information, and determines whether or not the condition variable is matched with the user information.

In case that plural condition variables matched with the user information exist, points corresponding to the condition variables are compared. Then, an advertisement corresponding to the highest point is displayed.

In case that only advertisement control data 12 is transmitted in advance from the advertisement system 100 to the user receiver 200, the user receiver 200 may require an advertisement having the highest point to the advertisement system 100 and receive the advertisement from the advertisement system 100. However, in case that advertisements 11 and corresponding advertisement control data 12 are transmitted from the advertisement system 100 to the user receiver 200, a process of requiring an advertisement having the highest point to the advertisement system 100 may be omitted.

The process of comparing the condition variable with the point may be performed when the user views a specific channel in which a given advertisement is provided.

A broadcasting transmission system 300 transmits programs and advertisements X(31) in accordance with a program log. In FIG. 1, the advertisement system 100 is separated from the broadcasting transmission system 300, but the advertisement system 100 and the broadcasting transmission system 300 may be embodied as one system. This will be immediately obvious to those skilled in the art. Here, the broadcasting advertisement X(31) may be an advertisement inserted in the middle of one program, or an advertisement inserted between one program and another program.

The broadcasting advertisement X(31) is an advertisement provided through a channel which the user is viewing presently.

The broadcasting of the present invention means a process of viewing contents transmitted to every user receivers 200 in the network through the network without limit.

The broadcasting includes a terrestrial broadcasting, a satellite broadcasting, a cable broadcasting, data transmission through an Internet protocol television IPTV and so on. Here, advertisement control data 32 may be matched with the broadcasting advertisement X(31) outputted from the broadcasting transmission system 300.

The advertisement control data 32 matched with the broadcasting advertisement X(31) is transmitted to the user receiver 200 with the broadcasting advertisement X(31), or is separately transmitted to the user receiver 200. Preferably, the advertisement control data 32 matched with the broadcasting advertisement X(31) may be transmitted to the user receiver 200 before the broadcasting advertisement X(31) is provided to the user receiver 200.

In one example embodiment of the present invention, the advertisement control data 32 may have further advertisement identification information for identifying the matched broadcasting advertisement X(31).

For example, it is assumed that the broadcasting advertisement X(31) is an advertisement “special event for this month in an LG home shopping”, and a corresponding advertisement control data 32 has a condition variable X and a point 55.

The broadcasting advertisement X(31) and the advertisement control data 32 are transmitted to the user receiver 200 from the broadcasting transmission system 300.

In case that the broadcasting advertisement X(31) and the advertisement control data 32 are transmitted to the user receiver 200 in accordance with channel view of the user, the user receiver 200 detects the condition variable and the point included in the advertisement control data 32. That is, the user receiver 200 verifies the condition variable X and the point 55. Then, the user receiver 200 reads the condition variable and the point, included in the advertisement control data 12 for the advertisements 11, from the storage medium 201.

In case that the advertisement control data 32 having the condition variable and the point is matched with the broadcasting advertisement X(31), the user receiver 200 may compare the pre-transmitted condition variable included in the advertisement control data 12 and the condition variable included in the broadcasting advertisement X(31) with the user information. Then, the user receiver 200 may display an advertisement having a condition variable corresponding to highest point of the above condition variables matched with the user information.

In case that it is determined that the point of the pre-stored advertisement control data 12 is the highest value in accordance with the comparison result, the advertisement in the pre-stored advertisement control data 12 is substituted for the broadcasting advertisement X(31).

Hereinafter, a process of displaying an advertisement on the user receiver 200C will be described. Here, it is assumed that the user receiver 200C stores the advertisement control data 12 and the advertisement 11 through the storage medium 201C, and pre-receives and stores the advertisement control data 32 for the broadcasting advertisement X(31) before the broadcasting advertisement X(31) is provided. Additionally, the user information 202C is set to be matched with condition variables P, R and X.

Particularly, the condition variable P indicates “a case that the user views one time or more a LG home shopping channel in last month”, and it is verified through the user information 202C of the user receiver 200C that the user views the LG home shopping channel two times (average) a day in last month. The condition variable R means “a case that the user purchases a video on demand in recent three days”, and it is verified through the user information 202C that the user buys the video yesterday. The condition variable X indicates “a case that the user views a movie in recent three days”, and it is verified through the user information 202C that the user views a movie “terminator” two hours ago.

Now referring to FIG. 1, the condition variable P and the condition variable R are included in the advertisement control data 12A and the advertisement control data 12B matched with the advertisement 11A and the advertisement 11B, respectively. The condition variable X is included in the advertisement control data 32 matched with the broadcasting advertisement X(31) to be provided through a specific channel. As a result, the broadcasting advertisement X(31), the advertisement 11A and/or the advertisement 11B will be displayed on a screen for the user.

The advertisement to be displayed on the screen is determined by score of the points included in the advertisement control data 12A, 12B and 32. In other words, an advertisement having the highest point is displayed on the screen.

For example, the advertisement control data 12A has the point 50, the advertisement control data 12B has the point 70, and the advertisement control data 32 of the broadcasting advertisement X(31) has the point 55. Here, since the point of the advertisement 11B has highest value, the advertisement 11B is determined as an advertisement to be displayed. Accordingly, the user receiver 202C displays the advertisement 11B instead of the broadcasting advertisement X(31) through the screen. Here, the advertisement control data 12B has address information of a server for providing the advertisement 11B in case that the advertisement 11B is provided with download and play type.

On the other hand, in case that the condition variable matched with the user information 202A is limited as a condition variable S as shown in the user receiver 200A, the advertisement 11C instead of the broadcasting advertisement X(31) is displayed on the screen.

In case that the condition variables P, X and Z are matched with the user information 202B as shown in the user receiver 200B, the broadcasting advertisement X(31) having highest point of the advertisement 11A, the advertisement 11N and the broadcasting advertisement X(31) is displayed on the screen. In case that the condition variables X and Z are matched with the user information 202M as shown in the user receiver 200M, the broadcasting advertisement X(31) having higher point of the broadcasting advertisement X(31) and the advertisement N is displayed on the screen.

That is, since the broadcasting advertisement X(31) is most matched with the user information 202 in the user receivers 200B and 200M, the broadcasting advertisement X(31) is not replaced.

In the above description, the advertisement control data 32 is matched with the broadcasting advertisement X(31). However, the advertisement control data 32 matched with the broadcasting advertisement X(31) does not exist. Here, the condition variable corresponding to the advertisement control data 12 stored in the storage medium 201 is compared with the user information 202. Then, the advertisement having highest point of the advertisements may be substituted for the broadcasting advertisement X(31).

In addition, the broadcasting transmission system 300, rather than transmitting the broadcasting advertisement X(31), may transmit a broadcasting program having indicated broadcasting advertisement section to the user receiver 200. Then, the user receiver 200 may insert an advertisement matched with the user's favor in the broadcasting program by using the condition variable and the point, and display the advertisement on the screen.

In brief, the personalized advertisement may be provided to the user by setting the advertisement control data through various methods.

In one example embodiment of the present invention, a plurality of condition variables having different points may be included in the advertisement control data matched with one advertisement. For example, the advertisement control data assigned to the advertisement X may have a condition variable having different points, i.e. “a first case that an advertisement display time is 30 seconds, and the user views one time or more a movie in recent 3 days, a point of the first case is 50”, and “a second case that the advertisement display time is 30 seconds and the user purchases a video on demand in recent 3 days, a point of the second case is 60”. Here, in case that one of the cases for the condition variable is matched with the user information 202, the advertisement X is determined as one of advertisements to be displayed. Then, the advertisement X may be displayed through comparison of points for given condition variables. In other words, in case that the condition variable “the first case that an advertisement display time is 30 seconds, and the user views one time or more a movie in recent 3 days” is satisfied, effect corresponding to the point 50 is generated. In case that the condition variable “the second case that the advertisement display time is 30 seconds and the user purchases a video on demand in recent 3 days” is satisfied, effect corresponding to the point 60 is generated.

In another example embodiment of the present invention, the advertisement control data may include a plurality of condition variables having the same point. For example, the advertisement control data 12 may have a first condition variable, i.e. “a first case that the user views one time or more a movie in recent 3 days, a point of the first case is 60”, a second condition variable, i.e. “a second case that the user purchases a video on demand in recent 3 days, a point of the second case is 60”, and a third condition variable, i.e. “a third case that the user views a channel 3 in recent a week, a point of the third case is 60”.

In still another example embodiment of the present invention, the advertisement control data may have a first condition variable and a first point as primary condition, and a second condition variable and a second point as secondary condition. For instance, the advertisement control data may have “the condition variable P and the point 55 as the primary condition, and the condition variable R and the point 80 as the secondary condition”. Here, the point 55 is used as the point of the advertisement control data in case that the condition variable P is satisfied, and the point 80 is used as the point of the advertisement control data in case that the condition variable R not P is satisfied.

In still another example embodiment of the present invention, for a specific advertisement, e.g. a public anti-smoking campaign, an inclusive condition for satisfying every condition (having the same effect as * for file search) may be set as the condition variable. In addition, a point matched with the condition variable is set. Here, it is desirable that the inclusive condition is set to only a part of the advertisements 11 stored in the storage medium 201.

Hereinafter, a specific advertisement, a condition variable and a point included in an advertisement control data corresponding to the advertisement will be described as an example.

(1) In case of “event advertisement: special event for this month in LG home shopping”—a first advertisement control data has a condition variable “case that the user views at least one time a day (average) an LG home shopping channel in last month” and a point 60, or has a condition variable “case that the user purchases goods through the LG home shopping channel in recent a week” and a point 95. The condition variable of the present invention may be defined as at least one of a user's act (viewing), act objection (LG home shopping channel), act period (one month) and act number (at least one time a day) as mentioned above.

The advertisement system 100 may output an interface having an input section for inputting at least one of the user's act/objection/period/number based on the specific advertisement when a manager is joined. The manager may input desired act, objection, period and number in the input section, and set corresponding point.

(2) In case of “goods advertisement: a navigator for a car”—a second advertisement control data has a condition variable “case that the user purchases (act) small telecommunication (IT) goods (objection) in recent 6 months (period)” and a point 80.

(3) In case of “video on demand: terminator 7” advertisement—a third advertisement control data has a condition variable “case that the user views (act) a SF movie (objection) in recent one month (period)” and a point 60, or a condition variable “case that the user purchases (act) a video on demand (objection) in recent 3 days (period)” and a point 89.

As described above, the point corresponding to the condition variable for one advertisement may be variously set in accordance with at least one of a user's act/objection/period/number.

(4) In case of “goods advertisement: a blouse”—a fourth advertisement control data has a condition variable “case that the user views one time or more a home shopping channel in recent 3 days”, a condition variable “case that the user purchases a clothes in recent one month” and a point 89. That is, a plurality of condition variables having the same point is set for one advertisement.

(5) In case of “public advertisement: anti-smoking campaign”—fifth advertisement control data has a condition variable “every condition (inclusive condition)” and a point 25.

(6) In case of “public advertisement” environmental campaign”—sixth advertisement control data has a condition variable “every condition (inclusive condition)” and a point 80. Here, the point is set as 60 in case that the advertisement is displayed one time on the screen of the user, and is set as 40 in case that the advertisement is displayed two times on the screen. Additionally, the advertisement is deleted in case that the advertisement is displayed three times on the screen.

In the advertisements (5) and (6) above, the condition variable may include option of “deletion.”

The condition variable of the present embodiment may further include additional information such as an advertiser, kind of an advertisement (goods advertisement, service advertisement, enterprise image advertisement, etc.), advertise type (drama, animation, etc.), advertisement goods, advertisement character (homey atmosphere, exotic atmosphere, etc.), user's age, user's sex, user's job and user's hobby.

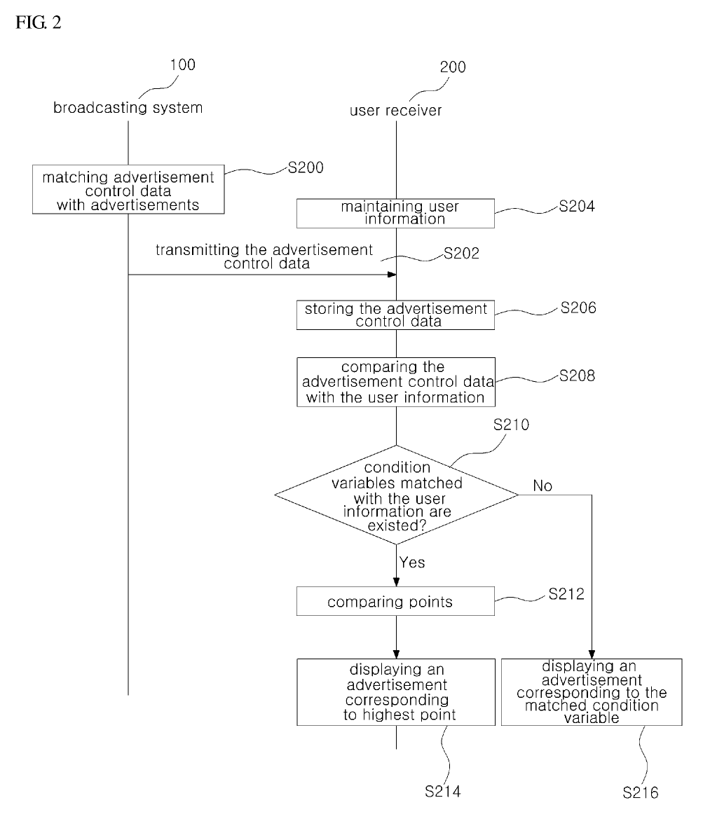

FIG. 2 is a flowchart illustrating a process of providing an advertisement according to one example embodiment of the present invention.

In step S200, the advertisement system 100 matches the advertisement control data 12 having a condition variable and a point with advertisements 11.

In step S202, the advertisement system 100 transmits the advertisement control data 12 to the user receiver 200.

In step S204, the user receiver 200 maintains the user information related to broadcasting view of the user through channel selection of the user, purchase goods from the home shopping and information inputted directly by the user.

In step S206, the user receiver 200 stores the advertisement control data 12 transmitted from the advertisement system 100.

In step S208, the user receiver 200 compares the condition variable in the stored advertisement control data with the user information.

The step S206 is a process of searching a condition variable matched with the user information.

In step S210, the user receiver 200 determines whether or not condition variables matched with the user information exist.

In step S212, in case that the condition variables exist, points for the condition variables are compared.

In step S214, the user receiver 200 displays an advertisement corresponding to the condition variable having highest point on the screen of the user.

In case that the user receiver 200 receives in advance a corresponding advertisement 11 with the advertisement control data 12 from the advertisement system 100 in the step S212, the user receiver 200 displays the advertisement 11. Otherwise, the user receiver 200 requires an advertisement 11 corresponding to highest point to the advertisement system 100, and then receives the advertisement 11 from the advertisement system 100.

In step S216, the user receiver 200 may display an advertisement 11 corresponding to the condition variable without a process of comparing the points in case that only one condition variable exists in the step S210.

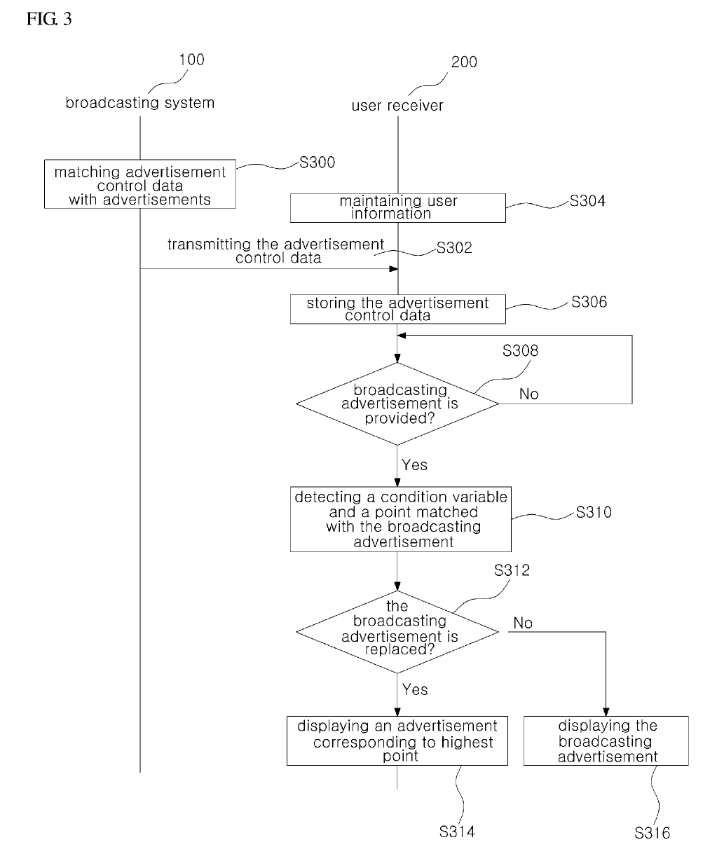

FIG. 3 is a flowchart illustrating a process of providing an advertisement according to another example embodiment of the present invention.

FIG. 3 shows a process of comparing a condition variable and a point when a user views a given channel for providing the broadcasting advertisement X(31), wherein the advertisement control data 32 is matched with the broadcasting advertisement X(31).

Since the steps S300 to S306 are the same as in the steps S200 to S206 in FIG. 2 except a process of providing the broadcasting advertisement X(31) with the advertisement control data 32, any further description concerning the same steps will be omitted.

Referring to FIG. 3, in step S308, the user receiver 200 determines whether or not the broadcasting advertisement X(31) is provided through a channel selected by the user.

In case that the broadcasting advertisement X(31) is provided through the channel, the user receiver 200 detects the condition variable and the point of the advertisement control data 32 matched with the broadcasting advertisement X(31) in step S310.

In step S312, the user receiver 200 determines whether or not the broadcasting advertisement X(31) is replaced. Here, the step S312 is a process of comparing the condition variable for the broadcasting advertisement X(31) and condition variables for the pre-stored advertisements 11 with the user information 202, and verifying a point corresponding to the condition variable matched with the user information 202.

In step S314, in case that the condition variable for the pre-stored advertisement 11 is more matched with the user information 202 compared to the broadcasting advertisement X(31) or the point for the pre-stored advertisement 11 is higher than that for the broadcasting advertisement X(31), the user receiver 200 substitutes the advertisement 11 having highest point for the broadcasting advertisement X(31), and displays the substituted advertisement 11.

However, in case that the pre-stored advertisement 11 matched with the user information 202 does not exist or the point for the broadcasting advertisement X(31) is higher than the points for the pre-stored advertisement 11, the user receiver 200 displays the broadcasting advertisement X(31) in step S316.

In FIG. 2 and FIG. 3, the advertisement control data and the advertisements may be transmitted to the user receiver 200 through various routes. Generally, a broadcasting network and a communication network may be used. It is desirable to transmit the advertisement control data and the advertisements the user receiver 200 through the communication network. The transmission through the communication network may be performed by a push mode, periodic requirement of the user receiver 200 and following download mode, fusion transmission method of broadcasting and communication, requirement in accordance with metadata and a receiving mode, etc.

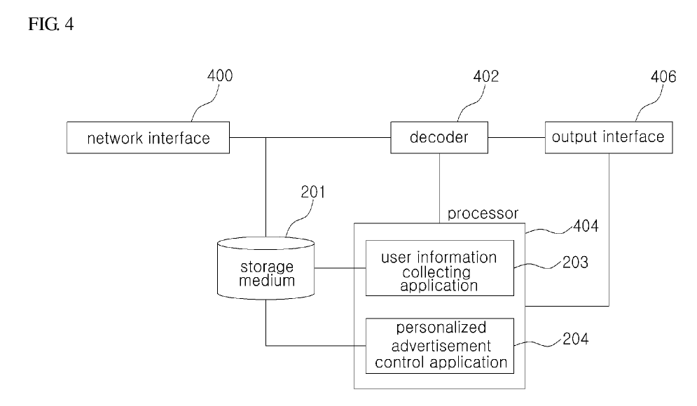

The user receiver can be realized by various ways. FIG. 4 shows block diagram illustrating an example of the user receiver according to one example embodiment of the present invention.

The user receiver 200 as a hardware layer includes a network interface 400 for exchanging data, the storage medium 201 for storing the user information 202, the advertisement 11 and the advertisement control data 12 matched with the advertisement 11, a decoder 402 for decoding data, a processor 404 for processing data and an output interface 406 for outputting data to the screen of the user.

The network interface 400 has a broadcasting network interface and an interactive interface for a communication network.

In the broadcasting system 100 according to one example embodiment of the present invention, it is desirable that the advertisement 11 and the advertisement control data 12 are transmitted to the user receiver 200 through the interactive interface. The channel viewed by the user is usually received through the broadcasting network interface. However, in case that the channel is a download and play typed channel, the channel may be received through the interactive interface.

In one example embodiment of the present invention, the user receiver 200 may have an application (or user information collecting application) 203A to 203M, i.e. 203 (in FIG. 1) for collecting the user information 202 and an application (personalized advertisement control application) 204A to 204M, i.e. 204 for providing the personalized advertisement.

The user information collecting application 203 is well-known by one of ordinary skill in the art to which this invention belongs. Here, the user information 202 may be collected through various methods. In addition, the collected user information 202 is stored in the storage medium 201 of the user receiver 200, but is not exposed to an outside. Accordingly, security information may be added to the user information 202.

The personalized advertisement control application 204 includes a function of performing interpretation of the advertisement control data, a function of comparing the user information 202 with the advertisement control data, a function of determining an advertisement to be displayed on the screen on the basis of the condition variable and the point included in the advertisement control data, and a function of commanding play of the selected advertisement.

The personalized advertisement control application 204 interprets the advertisement control data when the advertisement control data is received, compares the condition variable included in the advertisement control data with the user information 202, detects the advertisement control data having the condition variable matched with the user information 202, interprets the point of the detected advertisement control data, and commands play of the advertisement having highest point.

It is desirable that the personalized advertisement control application 204 is embodied with combination of sub-applications.

In one example embodiment of the present invention, the personalized advertisement control application 204 may register the advertisement control data having the condition variable matched with the user information 202.

In this case, the user receiver 200 may further include an advertisement control data registry. For example, the personalized advertisement control application 204 collects the user information 202, registers in advance the advertisement control data having the condition variable matched with the collected user information 202, and verifies in advance the point of the registered advertisement control data. Then, the personalized advertisement control application 204 determines the advertisement to be displayed on the screen of the user on the basis of the condition variable and the point of the advertisement control data. It is possible to select more rapidly the advertisement through the above process.

In addition, the personalized advertisement control application 204 may control deletion of the pre-stored advertisement.

In one example embodiment of the present invention, the user receiver 200 receives in advance a plurality of advertisements from the advertisement system 100. Here, individual deletion condition may be set about the advertisements. For instance, the advertisement may be deleted when the advertisement is displayed by a preset number or when is not displayed during the given period. That is, the deletion condition may be variously set.

The personalized advertisement control application 204 determines whether or not the pre-stored advertisement satisfies the deletion condition, and deletes the advertisement satisfying the deletion condition from the storage medium 201.

An effective period concerning the matched advertisement may be set to the advertisement control data. In this case, the user receiver 200 may delete a corresponding advertisement in case that the effective period elapses.

In case that the user receiver 200 receives a non-activation message from a headend such as the advertisement system 100, the user receiver 200 may delete a corresponding advertisement.

The methods for providing personalized advertisements according to the above-described embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A method of providing an advertisement to a user receiver coupled to an advertisement system through a network, the method comprising:
maintaining user information related to user's video view;
receiving from the advertisement system respective first advertisement control data corresponding to a plurality of first advertisements, wherein the respective first advertisement control data includes at least one first condition variable and at least one first point;
comparing the user information with the first condition variable or variables; and
displaying, when first conditional variables matched with the user information exist, an advertisement corresponding to a first condition variable having the highest first point among the first condition variables matched with the user information.

2. The method of claim 1, wherein the first condition variable is set to have different points for one advertisement.

3. The method of claim 1, wherein the first condition variable is set to have same point for one advertisement.

4. The method of claim 1, wherein the first condition variable has an inclusive condition for displaying automatically a corresponding advertisement in case that a preset time is reached.

5. The method of claim 1, wherein the first condition variable includes information of user's act related to video view, purchase or both, information of object of the user's act, information of period of the act, information of frequency of the act, or any combination thereof.

6. The method of claim 5, wherein the object information includes a channel viewed by the user, a video on demand or a genre in case that the act information is defined as video view of the user.

7. The method of claim 5, wherein the object information includes at least one of a goods purchased by the user, a video on demand and a channel on demand in case that the act information is defined as purchase of the user.

8. The method of claim 5, wherein the first point is set in accordance with one or more of the act information, the object information, the period information and the frequency information for one advertisement.

9. The method of claim 5, wherein the first condition variable further includes advertisement displaying time information.

10. The method of claim 9, wherein the first condition variable further includes additional information about user's favorite channel, area, age, hobby, or any combination thereof.

11. The method of claim 1, wherein the user information includes information about records of channels the user have watched, user's electronic commerce records, video view records, view time pattern, favorite channels, area, age or any combination thereof.

12. The method of claim 1, wherein in case that the user views a channel having a broadcasting advertisement corresponding to a second advertisement control data including at least one second condition variable and at least one second point, the second condition variable and the first condition variable received in advance through the advertisement system are compared with the user information.

13. The method of claim 12, wherein in case that the first point included in the first advertisement control data received in advance through the advertisement system is higher than the second point matched with the broadcasting advertisement, the advertisement corresponding to a first advertisement control data having the highest point is substituted for the broadcasting advertisement.

14. The method of claim 12, wherein the second advertisement control data matched with the broadcasting advertisement is transmitted in advance to the user receiver from a broadcasting transmission system before the user views a channel.

15. The method of claim 14, wherein the advertisement having the highest point is determined in advance before the user views the channel displaying the broadcasting advertisement.

16. The method of claim 1, wherein the advertisement is received with a corresponding advertisement control data.

17. The method of claim 16, wherein the first advertisement control data further includes an effective period for the first advertisement matched therewith such that the first advertisement is deleted when the effective period is elapsed.

18. The method of claim 18, further comprising:
updating display frequency of the advertisement at a preset time interval; and
deleting the advertisement and the corresponding advertisement control data in case that the display frequency is less than a preset number.

19. A method of providing advertisements through an advertisement system coupled to a user receiver through a network, the method comprising:
matching advertisement control data with advertisements, wherein the advertisement control data includes at least one condition variable and at least one point; and
transmitting the advertisements and the advertisement control data to the user receiver,
wherein the user receiver compares user information related broadcasting view with the condition variables included in the advertisement control data, and displays, when condition variables matched with the user information exist, an advertisement corresponding to a condition variable having the highest point among the condition variables matched with the user information.

20. A storage medium encoded with a machine-readable computer program for implementing a method for providing personalized advertisements, the method comprising:
storing advertisement control data for advertisements, wherein the advertisement control data includes at least one condition variable and at least one point;
comparing preset user information with condition variables included in the advertisement control data; and
displaying, when condition variables matched with the user information exist, an advertisement corresponding to a condition variable having the highest point among the condition variables matched with the user information.
